(19) United States
(12) Patent Application Publication
(10) Pub. No.: US 2007/0285743 A1
(43) Pub. Date: Dec. 13, 2007

(54) Image forming apparatus and image forming method

(75) Inventor: Masatsugu Hirayama, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; Toshiba Tec Kabushiki Kaisha

(21) Appl. No.: 11/449,784

(22) Filed: Jun. 9, 2006

(51) Int. Cl. H04N 1/60

(52) U.S. Cl. 358/504; 358/1.9

(57) ABSTRACT

An image forming apparatus includes: a recording unit configured to record plural calibration data, an image forming unit configured to read out the plural calibration data and forming plural calibration patterns as images on a recording medium according to the plural calibration data read out, an ADF reading unit configured to automatically convey and read the recording medium having the plural calibration patterns formed thereon and output image data, an error judging unit configured to compare the image data with reference data prepared in advance to judge whether there is an error in reading of the plural calibration patterns, a calculating unit configured to receive plural image data corresponding to the plural calibration patterns read and compare the plural image data with plural reference image data prepared in advance, respectively, to calculate plural image correction amounts, an image processing unit configured to apply, according to the plural image correction amounts, image correction to image data of an original read anew, and a control unit configured to control the respective units in order to output, when the error judging unit judges that there is an error in the reading of the plural calibration patterns, an instruction signal in order to place the recording medium having the plural calibration patterns formed thereon on the ADF reading unit again and perform reading again when the recording medium is placed on the ADF reading unit again.

### BACKGROUND OF THE INVENTION

Recently, according to improvement of performance of image forming apparatuses such as a digital copying machine, integrated digital apparatuses having not only a copying function but also a function of a printer have been developed. Usually, in PPCs and MFPs (Multi-Function Peripherals), density and gradation characteristics and the like of an output image fluctuate because of environmental changes (temperature and humidity). Thus, a calibration pattern corresponding to a built-in pattern is outputted, the calibration pattern is placed on an original stand and read, and calibration for reflecting correction to a target value is executed. This makes it possible to obtain the density and gradation characteristics even if the environment fluctuates.

In this relation, a cited reference 1 (JP-A-2001-180090) discloses calibration patterns attached with identification codes in order to cause a user to recognize, when plural calibration patterns are outputted to plural printers from PCs and the like, respectively, which calibration patterns are printed to be associated with which printers. Such identification codes are used when one calibration pattern is associated with one printer.

However, for example, in the MFPs, calibration for printers is required other than calibration for copying. Thus, there is a problem in that the MFPs cannot always perform image correction with common calibration.

When the plural calibration patterns are read by, for example, an ADF (Auto Document Feeder), the calibration patterns cannot always surely be read and are read in a state in which sheets or the like are out of position. Thus, there is a problem in that it is impossible to surely read image data corresponding to the calibration patterns.

### BRIEF SUMMARY OF THE INVENTION

An embodiment of the invention is an image forming apparatus comprising:

a recording unit configured to record plural calibration data;

an image forming unit configured to read out the plural calibration data from the recording unit and form plural calibration patterns as images on a recording medium according to the plural calibration data read out;

an ADF reading unit configured to automatically convey and read the recording medium having the plural calibration patterns, which are formed as images, formed thereon and output image data;

an error judging unit configured to compare the image data read by the ADF reading unit with reference data prepared in advance to judge whether there is an error in reading of the plural calibration patterns;

a calculating unit configured to receive plural image data corresponding to the plural calibration patterns read by the ADF reading unit and compare the plural image data with plural reference image data prepared in advance, respectively, to calculate plural image correction amounts;

an image processing unit configured to apply, according to the plural image correction amounts calculated by the calculating unit, image correction to image data of an original read by the reading unit anew; and

a control unit configured to control the respective units in order to output, when the error judging unit judges that there is an error in the reading of the plural calibration patterns, an instruction signal in order to place the recording medium having the plural calibration patterns, which are formed as images, formed thereon on the ADF reading unit again, perform reading again when the recording medium is placed on the ADF reading unit again, cause the calculating unit to calculate, when the error judging unit does not judge that there is an error in the reading of the plural calibration patterns, the plural image correction amounts based on the image data of the calibration patterns read by the reading unit and store the plural image correction amounts in a storage area, subject, in a usual image forming operation mode, the image data of the original read by the reading unit anew to correction processing with the image processing unit on the basis of the image correction amounts, and cause the image forming unit to form an image on the recording medium according to the image data subjected to the correction processing.

### BRIEF DESCRIPTION OF THE SEVERAL VIEWS OF THE DRAWING

FIG. 1 is a block diagram showing an example of a structure of an image forming apparatus that is an embodiment of the invention;

FIG. 2 is a graph for explaining an example of corrected data calculation processing at the time of a calibration operation of the image forming apparatus;

FIG. 3 is a flowchart showing an example of a calibration operation using an ADF of the image forming apparatus;

FIG. 4 is an explanatory diagram showing an example of a calibration pattern output selection screen of the image forming apparatus;

FIG. 5 is an explanatory diagram showing an example of a calibration start instruction screen of the image forming apparatus;

FIG. 6 is an explanatory diagram showing an example of a calibration start instruction screen of the image forming apparatus;

FIG. 7 is a diagram showing an example of a calibration pattern of the image forming apparatus;

FIG. 8 is a graph showing a read value at the time when a sheet through ADF of the image forming apparatus is used;

FIG. 9A is a diagram showing an example of a calibration pattern output selection diagram of the image forming apparatus;

FIG. 9B is a diagram showing an example of a calibration pattern execution confirmation screen of the image forming apparatus; and

FIG. 10 is a sectional view showing an example of the image forming apparatus that uses the sheet through ADF.

### DETAILED DESCRIPTION OF THE EMBODIMENTS

An image forming apparatus and an image forming method that are an embodiment of the invention will be hereinafter explained in detail using the drawings.

The image forming apparatus according to the embodiment of the invention is an MFP (Multi-Function Peripherals) as an example. For example, the image forming apparatus requires different kinds of calibration under different modes for copying and for a printer. Moreover, the image forming apparatus also requires different kinds of calibration under different modes such as PS and PCL (page description languages) Thus, it is necessary to perform the calibration using at least plural calibration patterns.

Calibration processing under these plural modes is efficiently performed as described below in detail according to, for example, use of an ADF (Auto Document Feeder), a layout of a calibration pattern, and identification information added to the pattern.

<Image Forming Apparatus That is the Embodiment of the Invention>

(Structure)

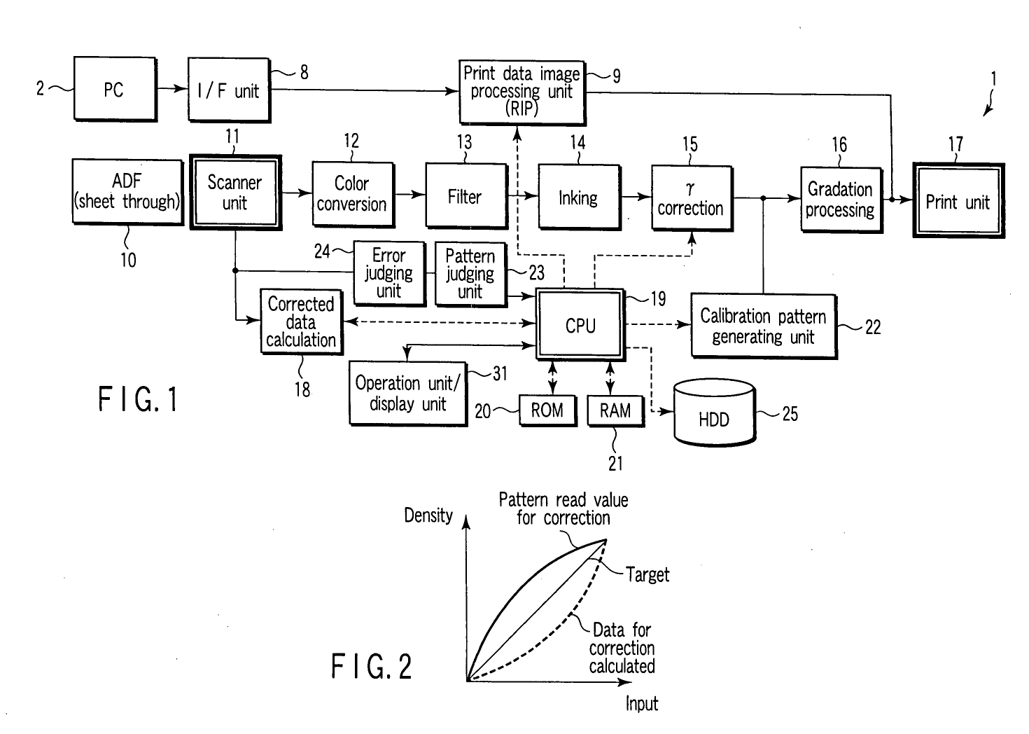

FIG. 1 shows an example of a structure of the image forming apparatus according to the embodiment of the invention. In FIG. 1, an image forming apparatus 1 includes an I/F unit 8 that receives image information and the like from a PC 2 and the like on the outside, a print data image processing unit (RIP: Raster Image Processor) 9 that performs image conversion processing to make it possible to print the image information and the like received, an ADF unit 10 that is an ADF (Auto Document Feeder) for automatically conveying an original and adopts an original stand reading system or a sheet through system described later, a scanner unit 11 that scans an original image; color conversion processing 12 that converts RGB image signals from the scanner unit 11 into CMY signals that are recording colors, a filter unit 13 that performs filtering processing, an black component generation unit 14 that generates a black signal from the CMY image signals and outputs CMYK signals; a γ correction unit 15 that subjects the CMYK signals to γ correction on the basis of corrected data stored in a RAM 11, a gradation processing unit 16 that further performs gradation processing, a calibration pattern generating unit 22 that is controlled by a CPU 19 to generate and supply a calibration pattern, a corrected data calculating unit 18 that is connected to the scanner unit 11, a CPU 19 that controls operations of the entire image forming apparatus 1, a ROM 20 connected to the CPU 19, and the RAM 21. These components are controlled by the CPU 19, respectively. An output of the calibration pattern generating unit 22 is supplied to an input of the gradation processing unit 16. The image forming apparatus 1 according to the embodiment of the invention further includes a print unit 17 that receives this print data and forms an image, a pattern judging unit 23 that judges a pattern on the image on the basis of image information supplied from the scanner unit 11, an error judging unit 24 that judges a reading error by the ADF 10, an HDD (Hard Disk Driver) 25 controlled by the CPU 19 and connected to the print data image processing unit 9 and the like, and an operation unit/display unit 31 that is connected to the CPU 19 and has various operation switches and an operation display screen.

(Basic Operation)

As an MFP, the image forming apparatus 1 having such a structure has a complex function of at least a printer function, a copy function, and the like. As the printer function, when the image forming apparatus 1 receives image information or the like from the PC 2 or the like on the outside using the I/F unit 8, under the control by the CPU 19, the image forming apparatus 1 subjects the image information or the like to image processing by the print data image processing unit 9 to change the image information or the like to a signal format, which can be printed by the print unit 17, and supplies the image information or the like to the print unit 17 to form an image on a recording medium. In this case, an image processing unit applies image processing corresponding to a calibration result to the image signal supplied.

In the image forming apparatus 1, as the copy function, under the control by the CPU 19, when plural originals or the like are placed on the ADF 10 and a start button or the like is depressed by operation of a user via the operation unit 31, the ADF 10 sequentially conveys the originals to a not-shown original stand and image information is read by the scanner unit 11. Thereafter, the image information such as RGB image signals is converted by the color conversion processing 12 into CMY signals, which are recording colors, and subjected to filtering processing by the filter unit 13. A black signal is generated from the CMY image signals by the black component generation unit 14 and CMYK signals are outputted. Moreover, the CMYK signals are subjected to γ correction reflecting the result of the calibration by the γ correction unit 15, subjected to gradation processing by the gradation processing unit 16, and supplied to the print unit 17. Consequently, an image is formed on a recording medium.

The calibration processing performed in the image forming apparatus 1 that performs the operations described above will be hereinafter explained in detail using the drawings. In this explanation, reading processing is applied to plural calibration patterns using an ADF and error judgment for judging whether there is a deficiency in this reading processing is performed.

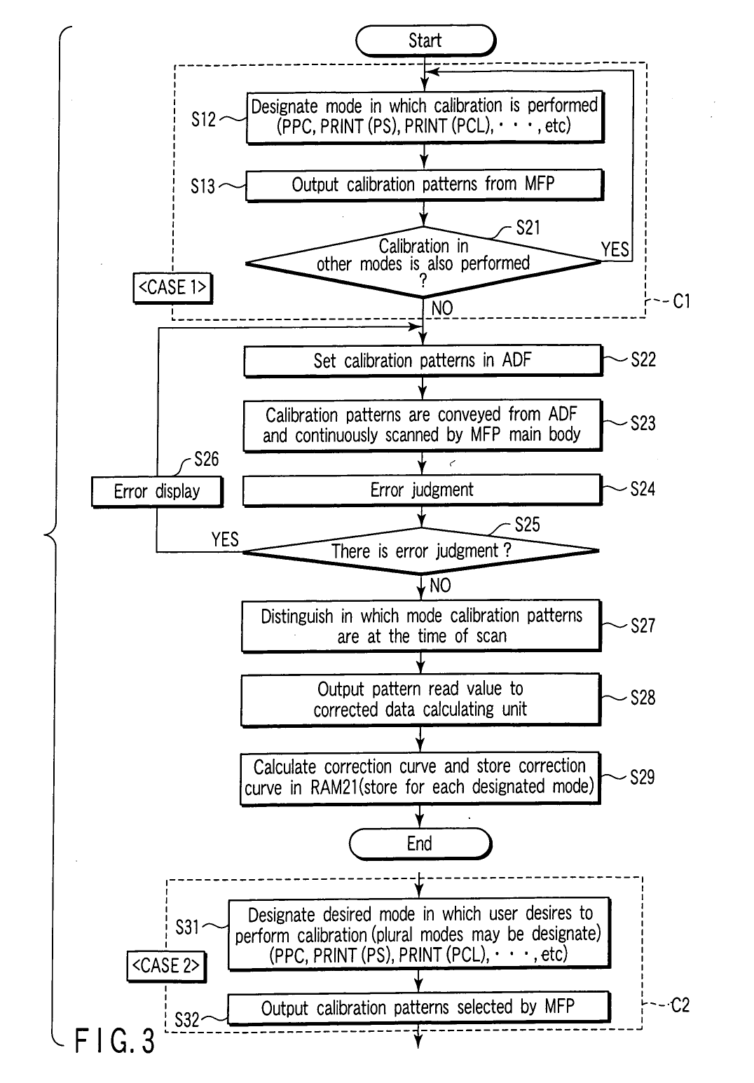

### First Embodiment: FIG. 3

A first embodiment specifies an image forming apparatus that reads plural calibration patterns with an ADF to perform calibration processing and, when it is judged that there is a reading error of the calibration patterns, performs image display to urge a user to perform reading operation again.

In an image forming apparatus such as an MFP that operates as a copier and a printer, in reading out plural calibration patterns corresponding to plural image formation modes, when it is impossible to judge which corrected patterns of the calibration patterns are patterns for which image formation modes, it is necessary to repeat output and reading of the corrected patterns and corrected data calculation by the number of times of implementation of calibration as a series of operations. Even if it is possible to judge in which image formation modes the corrected patterns are outputted, it is necessary to replace the corrected patterns every time to read the corrected patterns. A case in which an ADF (Auto Document Feeder) is used to simplify an operation for calculating corrected data from this reading will be described.

Moreover, it is highly likely that positional deviation is caused when plural calibration patterns are read by the ADF. Thus, the image forming apparatus detects the positional deviation, judges a reading error, and urges the user to perform setting operation for the ADF again.

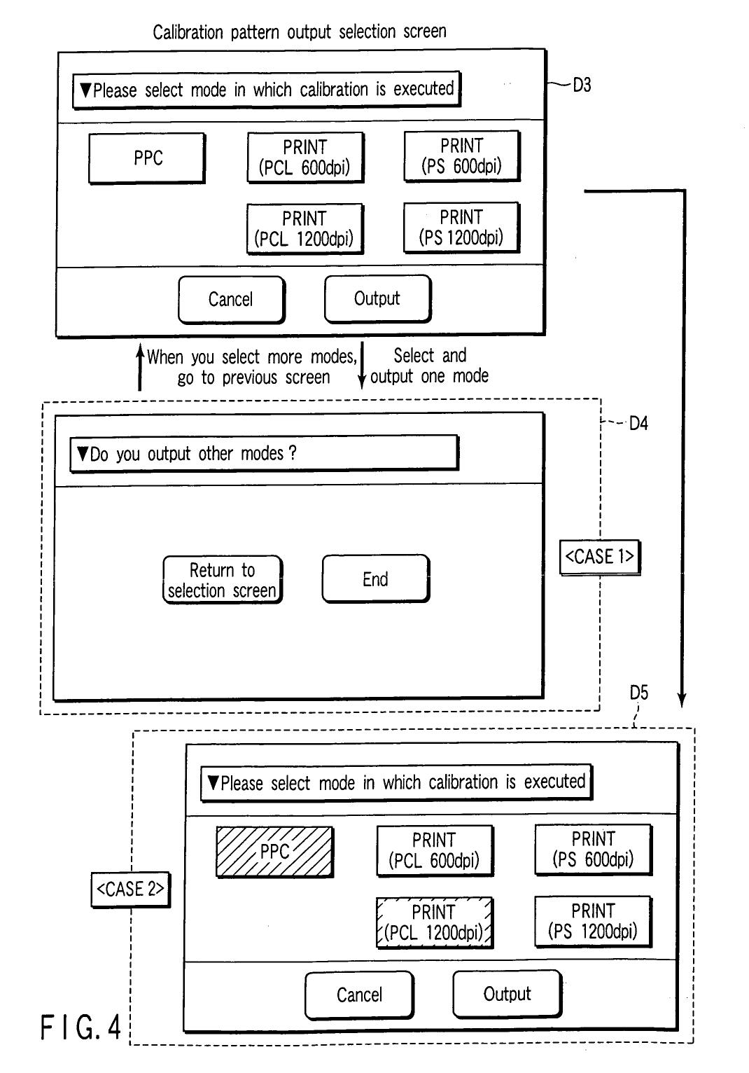

In a case 1C1 of a flowchart shown in FIG. 3, when the user selects one image formation mode, which the user desires to select, on a screen like a selection screen D3 in FIG. 4 (step S12), one calibration data corresponding to the image formation mode is outputted from the calibration pattern generating unit 22 or the HDD 25 (step S13). When the user also performs calibration of the other modes, on a screen D4 (step S21), the user returns to step S12, returns to the selection screen, and selects one desired image formation mode to perform image formation of a calibration pattern corresponding to the image formation mode (step S13).

It is also preferable to select plural image formation modes at a time. In a case 2C2, when the user selects plural image formation modes on an operation screen D5 in FIG. 4 (step S31), the image forming apparatus receives supply of calibration patterns from the calibration pattern generating unit 22 or the HDD 25 and print-outputs plural calibration patterns (S32).

In the CPU 19 or the like, it is preferable to store a print output order of these plural calibration patterns in a storage area to make use of the print output order for judgment of a mode of a calibration pattern described later.

The user sets these plural calibration patterns in the ADF 10 in operation of the user and depresses, for example, the start button or the like of the operation unit 31 (step S22). In this case, in reading out a calibration pattern using the ADF 10, as shown in FIG. 5, it is also preferable to display a message such as ‘set an outputted pattern in the ADF and depress the start key’ on the display unit 31 or the like and set the ADF 10 to operate on condition that the switch is depressed.

These plural calibration patterns are sequentially conveyed from the ADF 10, placed on the not-shown original stand, and sequentially read by the scanner unit 11 (step S23). Since the ADF 10 is used, the user does not have to place the plural calibration patterns on the original stand every time the plural calibration patterns are read. Thus, it is possible to perform smooth calibration processing for the plural image formation modes.

The error judging unit 24 judges whether these calibration patterns are surely read by the scanner unit 11 (step S24). An embodiment related to error detection at the time of calibration will be described.

Error Judgment Processing

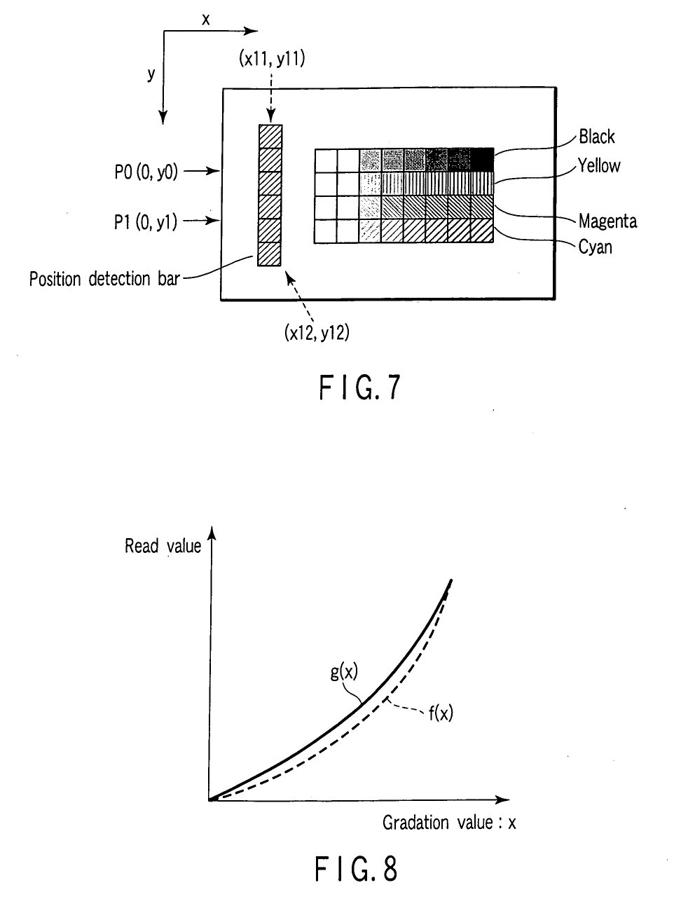

It is assumed that a layout of a calibration pattern is constituted by gradation patches of respective toner colors (black, yellow, magenta, and cyan) and a position detection bar (solid black) as shown in FIG. 7. An advancing direction of a reading unit (line scan) with respect to the calibration pattern is assumed to be an x direction in the figure. Two points of P0 and P1 shown in the figure indicate measurement start positions for calculating coordinates of the position detection bar. Top coordinates of the position detection bar are calculated at the two points for every line data transmitted from the reading unit as described below. Note that y0, y1, y11, and y12 are set in a relation of y11<y0,y1<y12.

(x,y0): if (R0<THR&&G0<THG&&B0<THB) then P0x=cx0 else cx0+

(x,y1): if (R1<THR&&G1<THG&&B1<THB) then P1x=cx1 else cx1++

(R0,G0,B0) is an RGB read value of one line data in a y0 coordinate of P0. Similarly, (R1,G1,B1) is a value for P1. THR, THG, and THB are thresholds for detection of the position detection bar. cx0 and cx1 are counters for calculating x coordinates P0x, P1x of an x direction top position of the position detection bar. At a point when both P0x and P1x are decided, in a line direction (a y direction), a start position P0y, Ply in the y direction is calculated by the same method. When an x coordinate at the time when both the P0x and P1x are decided is Px,

If (Rx0<THR&&Gx0)<THG&&Bx0<THB) then P0y=cy0 else cy0++

if (Rx1<THR&&Gx1<THG&&Bx1<THB) then P1y=cy1 else cy1++

### In the above expression, start coordinates of (Rx0,Gx0,Bx0) are assumed to be (Px,0) and start coordinates of (Rx1,Gx1,Bx1) are assumed to be (Px+w,0). Note that w satisfies the condition 0<w<x12−x11.

When coordinates of these four points are decided, it is judged that the position detection bar has been successfully specified. Note that, when P0x and P1x are substantially different or when Py0 and Py1 are substantially different, it is highly likely that the calibration pattern is conveyed in a substantially warped state or the pattern is set in an opposite direction. Thus, the judgment is corrected to indicate that the position detection bar has not been successfully specified. An instruction is displayed to set the calibration pattern in a correct position again.

When the position detection bar has been successfully specified as described above, reading of gradation patterns of the respective colors is started. In this case, if a pattern is removed while the reading unit is reading the pattern, it is impossible to correctly perform calibration. In the case in which a sensor that can detect opening of an original cover is mounted, at a point when the sensor detects opening of the original cover during a reading operation, it is possible to notify the user to that effect and urge the user to try the reading again. However, when there is no detecting means, it is impossible to detect an error and the reading operation is continued. As a result, a desired calibration result is not obtained.

Therefore, in order to solve such a deficiency, attention is paid to, for example, a gradation pattern of black in FIG. 7. It is preferable to compare a read value of a patch with lowest density and a read value of a patch with highest density with a reference value determined in advance and judge, when both the read values are within a fixed value, calibration is normal and, when at least one of the read values exceeds the fixed value, an error has occurred.

It is also preferable to add a patch with intermediate density in the calibration pattern as a reference, calculate a difference of read values at the three points, and compare the difference with density of this patch with intermediate density to perform error detection in the same manner.

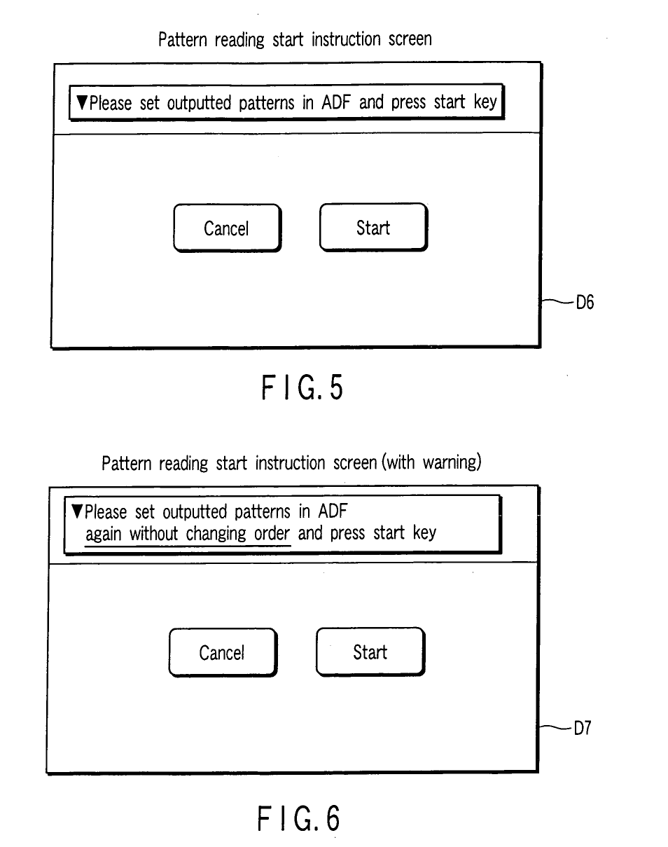

The error judgment is performed in this way and, when a judgment result indicates no error (step S25), the image forming apparatus directly proceeds to step S27. However, when a judgment result indicates an error, it is preferable to display a warning message such as ‘set the outputted pattern in the ADF again without changing the order and depress the start key’ shown in FIG. 6 (step S26). The user sets the calibration patterns in the ADF again (step S22).

It is also preferable to, for example, clearly indicate on the screen display in FIG. 6 that the user should not change the order to cause the user to surely set the calibration patterns in the ADF 10 in an order of ‘PPC, PRINT (PS 600 dpi), PRINT (PS 1200 dpi), PRINT (PCL 600 dpi), and PRINT (PCL 1200 dpi)’ or the like.

Subsequently, the calibration patterns are sequentially conveyed to the original stand and continuously scanned to sequentially output image information using the ADF 10. In this case, to find which piece of the image information corresponds to which of the calibration patterns, it is preferable to use a print output order of the plural calibration patterns stored in the storage area by the CPU 19 or the like earlier. In other words, it is preferable to judge that the plural pieces of image information read out are identical with the print output order of the calibration patterns printed and perform the subsequent processing according to this judgment result.

The image forming apparatus supplies these pieces of image information read (pattern read values) to the corrected data calculating unit 18 (step S28). The image forming apparatus calculates a correction curve (data for correction) on the basis of a pattern read value for correction and a target value shown in a graph of FIG. 2 and, for example, via a control unit such as the CPU 19 or the like, stores the correction curve in the storage area RAM 21 for each mode designated (step S29). In this case, it is preferable to indicate on the display unit 31 for which image formation mode the calibration has ended.

Thereafter, in the printer function of the image forming apparatus 1, concerning the image information supplied from the PC 2 or the like, a correction amount of the print data image processing unit 7 is properly corrected according to the correction curve of the storage area RAM 21. In the copy function, the image information of the original placed on the scanner unit 11 or the like and scanned is subjected to color conversion, filter processing, inking, and the like and, then, subjected to image correction by γ correction corresponding to the correction curve of the RAM 21 corresponding to the calibration. The image information subjected to the image correction taking into account this calibration result is supplied to the print unit 17 and an image is formed on a recording medium as described in the first embodiment.

In this way, in the first embodiment, the error display or the like of the ADF 10 or the operation unit/display unit 31 is used to make it possible to perform more smooth calibration processing of plural modes.

### Second Embodiment

A second embodiment specifies an image forming apparatus that uses a sheet through system for an ADF together with the characteristics of the first embodiment. In the second embodiment, error judgment processing peculiar to the sheet through system is performed.

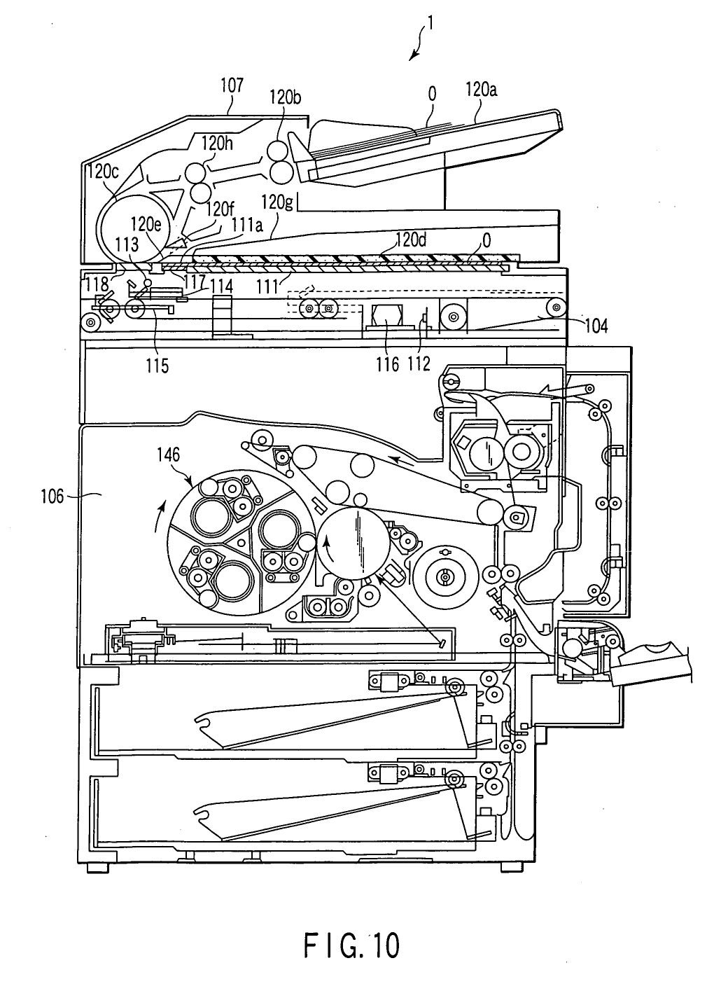

First, the image forming apparatus of the sheet through system will be explained using FIG. 10.

(Structure of the Image Forming Apparatus)

In FIG. 10, a color digital copying apparatus 1, which is an example of the image forming apparatus according to the invention, includes a color image reading apparatus (hereinafter referred to as scanner) 104 that reads image information held by an object to be copied O as brightness of light and generates an image signal, an image forming apparatus (MFP) 106 that forms an image corresponding to an image signal supplied from the scanner 104 or the outside, an auto document feeder (ADF) 107, and an operation panel 180 described later.

First, the ADF 107 can perform a reading operation in the sheet through system, that is, a system for fixing a reading position with an optical system such as a mirror or an image reading sensor and a lighting device set in predetermined positions in advance and, when objects to be read are sheet-like objects, conveying the objects to be read to the reading position in order. In sheet through reading, after originals O are set in a tray 120a of the ADF 107, when a not-shown reading start key is turned on (or reading is instructed from a not-shown external apparatus), an illuminating lamp 113 of a first carriage 114 is turned on and a white board 117 is lighted by the lamp 113. Therefore, reflected light is generated from the white board 117, reflected by an image extracting mirror 114a, a first image mirror 115a, and a second image mirror 115b in order, guided to a lens 116, given predetermined convergence by the lens 116, and focused on a light-receiving surface of a CCD sensor 112.

At the same time, a not-shown motor is rotated by a not-shown motor driving device to make it possible to move first and second carriages 114 and 115 in a predetermined direction. After being continuously accelerated, the drive motor is stopped at a pulse number that is defined such that the center in a length direction (a direction orthogonal to a depth direction) of the first mirror 114a of the first carriage 114 and the center in a length direction (a direction orthogonal to a depth direction) of a reading window 118 are opposed to each other. The pulse number is defined as a distance between, for example, a not-shown HP sensor and a not-shown light shielding plate provided in a predetermined position of the first carriage 114. The pulse number is corrected and set according to a magnitude of an inertial torque and intensity of a brake of the drive motor, weights of the first and the second carriages, tension of a wire rope, and the like. A correction amount for shading correction is set on the basis of the reflected light from the white board 117. This correction amount serves as a reference for thresholding an output signal of the CCD sensor 112.

Then, a feed roller 120b of the ADF 107 is rotated to extract one of the sheet-like originals O set in the tray 120a and conveyed, by an intermediate roller 120h and a conveying roller 120c, to a reading position where the reading window 118 and the conveying roller 120c are opposed to each other.

Subsequently, the illuminating lamp 113 of the first carriage 114 is turned on at predetermined timing, for example, simultaneously with the start of rotation of the conveying roller 120c. Therefore, the sheet-like original O passed through the reading position of the reading window 120 is lighted by strip-like illuminating light slender in the depth direction of the illuminating lamp 113.

At the same time, reflected light from the original O is reflected by the image extracting mirror 114a, the first image mirror 115a, and the second image mirror 115b in order, given convergence by the lens 116, and focused on the light-receiving surface of the CCD sensor 112.

Then, by rotation of the conveying roller 120c images of the sheet-like original O passed through the reading position of the reading window 120 in order. Consequently, reflected lights corresponding to the images over the entire area of the original O are focused on the light-receiving surface of the CCD sensor 112 in order.

The reflected light from the original O guided to the CCD sensor 112 is photoelectrically converted into a current value corresponding to light intensity of the reflected light by the CCD sensor 112. After being thresholded at a predetermined level by an A-D conversion/threshold circuit, the reflected light is subjected to voltage conversion. After being recognized as character information and image information through an image processing circuit, the reflected light is stored in an image memory as image data. In this case, when image information of the original O is only a monochrome image, it is possible to read the image information at speed twice as high as speed at which image light supplied to any one of R, G, and B or each of R, G, and B is processed.

On the other hand, the original O passed through the reading window 120 is released from contact with the reading window 120 by a pickup unit 120e of the ADF 107 and discharged to a reading object holding unit 120g via a pawl 120f slanted to a solid line side in advance. When the sheet-like original O has images on both sides thereof and duplex reading for reading the images on both the sides is instructed, the pawl 120f is slanted to a broken line side according to the control by a not-shown pawl control unit. Consequently, the sheet-like original O is temporarily returned to the feed roller 120b side through the intermediate roller 120h and, then, fed to the conveying roller 120c again to be guided to the reading window 120 with the front and the rear thereof reversed.

When there are second and subsequent sheet-like originals O, the sheet-like originals O are conveyed in the same manner.

In the example explained in the embodiments described above, images of originals are read using the ADF 7. However, it goes without saying that the ADF 107 is also applicable to a case in which originals are conveyed to an original table 111 one by one. In that case, a color image and a monochrome image are distinguished for each of the originals.

On the other hand, the printer unit 106 includes a laser exposure device that acts as latent image forming means. The laser exposure device includes a semiconductor laser serving as a light source, a polygon mirror serving as a scanning member that continuously deflects laser beams emitted from the semiconductor laser, a polygon motor serving as a scanning motor that drives the polygon mirror to rotate at a predetermined number of revolutions, and an optical system that deflects laser beams from the polygon mirror and guides the laser beams to a photosensitive drum 144 described later.

The printer unit 106 has a rotatable photosensitive drum 144 serving as an image bearing member disposed substantially in the center of the apparatus main body. A peripheral surface of the photosensitive drum 144 is exposed by a laser beam from the laser exposure device and a desired electrostatic latent image is formed on the peripheral surface. Moreover, the printer unit 106 includes a developing device unit 146 that supplies a toner serving as a developer to the electrostatic latent image formed on the peripheral surface of the photosensitive drum 144 and develops the electrostatic latent image at desired image density.

(Error Judgment Processing Peculiar to the Sheet Through System)

In an ADF of a sheet through type, a reading unit is fixed and an original is read while being conveyed through a position of the reading unit. Thus, compared with the original stand reading system for fixing an original on an original stand and reading the original, the ADF tends to be affected by paper thickness and elasticity of the original and a position where the original passes the reading unit changes. Thus, fluctuation may occur in read values. Therefore, compared with the case in which the original is set on the original stand, a difference occurs in the read values. It is likely that calibration results are different even if the same calibration pattern is used.

Thus, the error judging unit 24 performs correction processing taking into account an error between a reading position in the original stand reading system and a reading position in the sheet through system. Specifically, when it is assumed that read values of a specific gradation pattern is repeatedly sampled and a result in FIG. 8 is obtained, f(x)-g(x) is added to read values at the time of use of the ADF as a calibrated value to perform calibration. This makes it possible to improve accuracy. In f(x)-g(x), f(x) is a read value in the original stand reading system and g(x) is a read value in the sheet through system.

When the reading fluctuation is taken into account as described above, it is preferable to perform, when the ADF is used, reading operations plural times rather than once at the time of calibration, add a calibrated value with an average value of the reading operations as a read value, and use, when the ADF is used, a pattern with an increased patch size to further improve accuracy.

### Third Embodiment

A third embodiment specifies an image forming apparatus that provides information such as a date and time of calibration processing performed in the past and an image forming apparatus that provides timing for performing calibration.

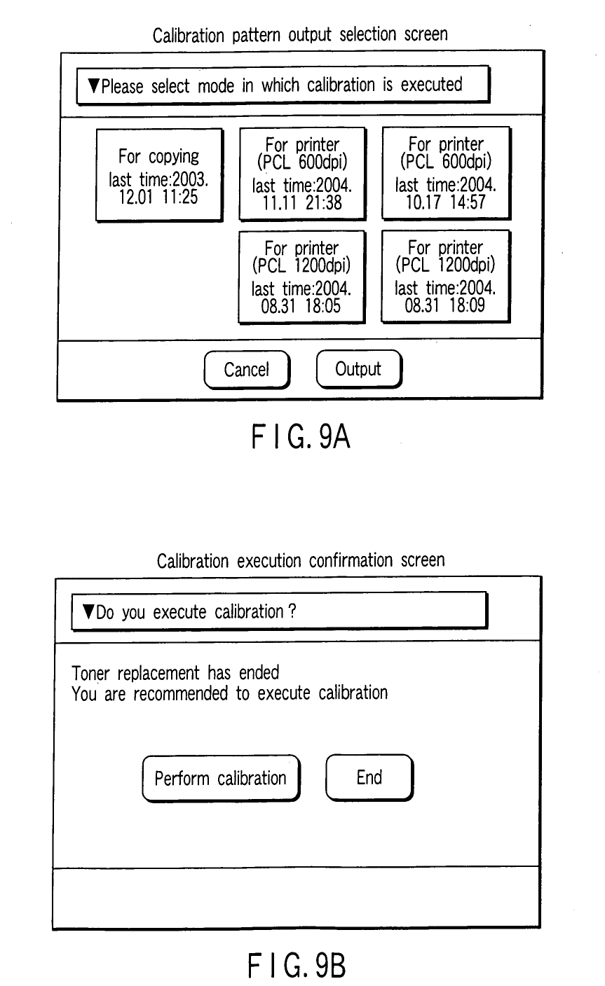

The image forming apparatus according to the third embodiment has the structure of FIG. 1, FIG. 10, or the like described above. In such a structure, the image forming apparatus displays history information of calibration shown in FIG. 9A on the operation unit/display unit 31 according to programs of the CPU 19, the ROM 20, and the RAM 21. Consequently, a user can judge, on an output pattern selection screen at the time of execution of calibration in FIG. 9A, that, for example, since calibration for copying has not been performed for a while, it is better to perform the calibration.

Similarly, as shown in FIG. 9B, the image forming apparatus displays a proposal screen of, for example, ‘toner replacement has ended. You are recommended to execute calibration’ at the time of toner replacement in the same manner according to the programs of the CPU 19, the ROM 20, and the RAM 21. Moreover, when calibration is not performed for a period designated in advance or a period set by the user, the image forming apparatus considers that “a . . . period has passed since the user executed calibration last time” and displays a screen for urging the user to perform calibration in the same manner. This makes it possible to prevent the user from forgetting to execute calibration.

Those skilled in the art can realize the invention according to the various embodiments described above. It is easy for those skilled in the art to devise various modifications of these embodiments. Those skilled in the art are capable of applying the invention to various embodiments without having an inventive ability. Therefore, the invention extends to a wide range not inconsistent with the disclosed principles and new characteristics and is not limited to the embodiments described above.

What is claimed is:

1. An image forming apparatus comprising:
a recording unit configured to record plural calibration data;
an image forming unit configured to read out the plural calibration data from the recording unit and form plural calibration patterns as images on a recording medium according to the plural calibration data read out;
an ADF reading unit (11) configured to automatically convey and read the recording medium having the plural calibration patterns, which are formed as images, formed thereon and output image data;
an error judging unit configured to compare the image data read by the ADF reading unit with reference data prepared in advance to judge whether there is an error in reading of the plural calibration patterns;
a calculating unit configured to receive plural image data corresponding to the plural calibration patterns read by the ADF reading unit and compare the plural image data with plural reference image data prepared in advance, respectively, to calculate plural image correction amounts;
an image processing unit configured to apply, according to the plural image correction amounts calculated by the calculating unit, image correction to image data of an original read by the reading unit anew; and
a control unit configured to control the respective units in order to output, when the error judging unit judges that there is an error in the reading of the plural calibration patterns, an instruction signal and display the instruction signal on a display unit in order to place the recording medium having the plural calibration patterns, which are formed as images, formed thereon on the ADF reading unit again, perform reading again when the recording medium is placed on the ADF reading unit again, cause the calculating unit to calculate, when the error judging unit does not judge that there is an error in the reading of the plural calibration patterns, the plural image correction amounts based on the image data of the calibration patterns read by the reading unit and store the plural image correction amounts in a storage area, subject, in a usual image forming operation mode, the image data of the original read by the reading unit anew to correction processing with the image processing unit on the basis of the image correction amounts, and cause the image forming unit to form an image on the recording medium according to the image data subjected to the correction processing.

2. An image forming apparatus according to claim 1, wherein the error judging unit compares a position of a position detection bar included in a calibration pattern on the recording medium with position information of the reference data given in advance and judges the position to judge whether there is an error.

3. An image forming apparatus according to claim 1, wherein the control unit outputs, when the error judging unit judges that there is an error in reading of the calibration pattern on the recording medium, a display signal in order to display the reading error.

4. An image forming apparatus according to claim 1, wherein the ADF reading unit reads image data of the recording medium according to a sheet through system.

5. An image forming apparatus according to claim 4, wherein the error judging unit performs correction processing taking into account an error between a reading position in an original stand reading system and a reading position in the sheet through system.

6. An image forming apparatus according to claim 1, further comprising: a display unit configured to display a date and time of calibration of last time according to a control signal given from the control unit.

7. An image forming apparatus according to claim 1, wherein the control unit outputs a control signal for proposing reading of the calibration pattern.

8. An image forming apparatus according to claim 1, wherein the control unit outputs a control signal for proposing reading of the calibration pattern at the time of toner replacement or after toner replacement.

9. An image forming apparatus comprising:
a recording unit configured to record calibration data;
an image forming unit configured to read out the calibration data from the recording unit and form a calibration pattern as an image on a recording medium according to the calibration data read out;
a reading unit configured to read the recording medium having the calibration pattern, which is formed as an image, formed thereon and output image data;
a calculating unit configured to receive image data corresponding to the calibration pattern read by the reading unit and compare the image data with reference image data prepared in advance, respectively, to calculate an image correction amount;
an image processing unit configured to apply, according to the image correction amount calculated by the calculating unit, image correction to image data of an original read by the reading unit anew; and
a control unit configured to control the respective units in order to output, at predetermined timing, a control signal to a screen display unit in order to perform screen display for proposing reading of the calibration pattern, when an operation signal for calibration processing is given from the outside in response to this proposal, form a calibration pattern as an image on a recording medium, reads image data of the calibration pattern with the reading unit, cause the calculating unit to calculate the plural image correction amounts based on the image data and store the image correction amount in a storage area, subject, in a usual image forming operation mode, the image data of the original read by the reading unit anew to correction processing with the image processing unit on the basis of the image correction amount, and cause the image forming unit to form an image on the recording medium according to the image data subjected to the correction processing.

10. An image forming apparatus according to claim 9, wherein the control unit outputs a control signal for performing the screen display for proposing reading of the calibration pattern at the time of toner replacement or after toner replacement.

11. An image forming method comprising the steps of:
reading out plural calibration data recorded in advance and forming plural calibration patterns as images on a recording medium according to the plural calibration data read out;
automatically conveying and reading the recording medium having the plural calibration patterns, which are formed as images, formed thereon using an ADF and outputting image data;
comparing the image data read with reference data prepared in advance to judge whether there is an error in reading of the plural calibration patterns;
reading out, when it is judged that there is an error in the reading of the plural calibration patterns, an instruction signal in order to read out the recording medium having the plural calibration patterns, which are formed as images, formed thereon using the ADF again, receiving an operation signal corresponding to the instruction signal, and reading the recording medium with the ADF again;
comparing, when it is not judged that there is an error in the reading of the plural calibration patterns, the image data of the calibration patterns with plural reference image data prepared in advance to calculate plural image correction amounts; and
applying image correction to image data of an original read anew according to the plural image correction amounts calculated and forming an image on the recording medium according to the image data subjected to correction processing.

12. An image forming method according to claim 11, wherein, in the error judgment, a position of a position detection bar included in a calibration pattern on the recording medium is compared with position information of the reference data given in advance and judged to judge whether there is an error.

13. An image forming method according to claim 11, wherein, when it is judged that there is an error in reading the calibration pattern on the recording medium, a display signal is outputted in order to display the reading error.

14. An image forming method according to claim 11, wherein processing for reading the recording medium by the ADF is performed according to a sheet through system.

15. An image forming method according to claim 14, wherein, in the error judgment processing, correction processing taking into account an error between a reading position in an original stand reading system and a reading position in the sheet through system is performed.

16. An image forming method according to claim 11, further comprising the step of: displaying a date and time of calibration of last time on a display unit.

17. An image forming method according to claim 11, further comprising the step of: performing screen display for proposing reading of the calibration pattern.

18. An image forming method according to claim 11, wherein the screen display for proposing reading of the calibration pattern is performed at the time of toner replacement or after toner replacement.

19. An image forming method comprising the steps of:
performing screen display for proposing calibration processing at predetermined timing;
reading out, when an operation signal for the calibration processing is given from outside in response to this proposal, calibration data recorded in advance and forming a calibration pattern on a recording medium as an image according to the calibration data;
reading the recording medium having the calibration pattern, which is formed as an image, formed thereon and outputting image data;
receiving image data corresponding to the calibration pattern read, comparing the image data with reference image data prepared in advance, respectively, and calculating an image correction amount; and
applying image correction to image data of an original read anew according to the image correction amount calculated and forming an image on the recording medium according to the image data subjected to correction processing.

20. An image forming method according to claim 19, wherein the screen display for proposing calibration processing is performed at the time of toner replacement or after toner replacement.
